(19) United States
(12) Patent Application Publication
(10) Pub. No.: US 2016/0343357 A1
(43) Pub. Date: Nov. 24, 2016

(54) FLEXIBLE AND INFLATABLE LUDIC INSTRUMENT

(71) Applicant: Roger YOKOYAMA, São Paulo (BR)

(72) Inventors: Roger Yokoyama, São Paulo (BR); Renan De Carvalho Pinto Moy, São Paulo (BR); Eduardo Fagnani, São Paulo (BR)

(73) Assignee: Roger Yokoyama, São Paulo (BR)

(21) Appl. No.: 15/110,846

(22) PCT Filed: Nov. 19, 2014
(86) PCT No.: PCT/BR2014/050017

§ 371 Date: Jul. 11, 2016

(30) Foreign Application Priority Data
Jan. 16, 2014 (BR) BR1020140010980

(51) Int. Cl. G10D 7/12; A63H 5/00; G10K 9/04

(52) U.S. Cl. CPC G10D 7/12; G10K 9/04; A63H 5/00

(57) ABSTRACT

A flexible and inflatable ludic instrument consisting of a hollow body made of suitable flexible plastic material, formed by an inner and an outer wall, which delimits an air chamber between them, which can be inflated through an air inlet valve provided therein, wherein, when inflated, the body takes the base shape of a horn, whose bottom part presents an anatomic handle adaptable to the user's hand, which is introduced in the inner tube formed by the body. The body is provided with an inner central air bag delimited by the flexible plastic material it is made of, the air bag presenting a central support handle for the user's hand, and a housing for the air pump connected to the sound reed, or for a properly wrapped honk; the activation of the air pump or for the honk by the user's hand producing an emission of sound from the instrument.

### SUMMARY OF THE INVENTION

The present Patent of Invention refers to a novel ludic instrument which shows, as great differential element, the fact of being flexible and inflatable, as well as the fact that, after it is inflated it is coupled and anatomically secured to the user's wrist, the hand of said user being inside of said instrument.

Furthermore, and representing a further differential element, such ludic instrument is provided with an inner air bag which can be continuously squeezed by the user's hand, leading to the formation of an air column inside the instrument, which is the responsible for sound emission.

### DESCRIPTION OF THE STATE OF THE ART

As it is known in the stale of the art, aerophones are instruments where the sound is produced through an air column which is caused to vibrate within or through the body of the instrument.

The most common and popular aerophone is the horn, whose plastic version is the most commercialized in the market, including as children toys; such plastic horns are also much used in parties and celebrations, as well as in sports competitions in general and, more specifically, in football matches, emitting loud and cheerful sounds and thus cheering the fans.

More recently, due to the World Cup held in South Africa in 2010, a traditional model of horn known as “vuvuzela” and whose origin dates back to ancient howls used by ancestral South African tribes has become internationally widespread; such model can emit very high and loud sounds, which is the reason why the use thereof by fans during matches has been growing, not only in order to produce sound, but also to perform combined and rehearsed choreographies.

Both plastic and “vuvuzelas” horns are mouthpiece-type aerophones, that is, aerophones whose sound Is produced by the air blown by the user's mouth, capable of creating said air column inside the instrument that, when vibrating, produces the emission of sound.

Despite the wide use of these horns and “vavuzelas”, these instruments present some drawbacks.

One of them lies in the fact that since these instrument are manufactured in hard plastic, they can be used as objects to throw or even as weapons, capable of accidental or intentionally hurt someone; for this reason, lately the use of these instruments, in some public places—namely football stadiums, has been prohibited.

Another drawback lies in the fact that, when used in choreographies, these horns and “vuvuzelas” are difficult to handle and, frequently slipping from the users' hand during the choreography and, thus, being not fully suitable to such a purpose.

A further drawback lies in the fact that, in order to emit a sound, these instruments need to be played by blowing, which requires a considerable users' effort, mainly upon prolonged use, frequently leading to users' weariness due to the overload of their respiratory system.

### OBJETIVES OF THE INVENTION

Keeping in mind these drawbacks and with the purpose of overcoming them, a completely innovative instrument, unique in the market was created, to wit, a “FLEXIBLE AND INFLATABLE LUDIC INSTRUMENT”, that constitutes the object of the present patent. This instrument consists of a hollow body, formed by double walls made of flexible plastic material which can be quickly inflated either manually or mechanically (with compressed air) through a small air inlet valve placed on it, the inflation of said hollow body resulting In the formation of an object having the basic shape of a horn provided with a handle adaptable to the user's hand, more specifically, to his/her wrist, remaining well secured thereto. In other words, upon inflating the instrument through the valve placed on it, the users hand may be introduced in the inner tube delimited thereby, in the fashion of a glove, said procedure being duly directed by its lower handle and, thus, leaving said instrument secured and anatomically adapted to the user's hand.

In another embodiment, the ludic instrument invented herein consists of a non-hollow body, that is, closed at both ends, likewise manually or mechanically inflatable through the same air inlet valve provided on it, the inflation of said hollow body resulting in the formation of an object with the shape of a truncated cone, likewise provided with a handle adaptable to the user's band, remaining well secured thereto.

Furthermore, the ludic instrument invented herein, both in the hollow-shape embodiment and in the closed-shape embodiment, is provided with a central inner air bag, delimited by the very flexible plastic material it is made of, wherein this air bag is placed to match the user's hand when he/she introduces his/her hand into the instrument, his/her fingers comfortably laying on said air bag; hence, said air bag works as a support handle in the center of the body delimited by the instrument and, thus, thanks to the former, the latter Is even better secured to the user's hand.

Therefore, being “worn” by a user's hand, the ludic instrument invented herein may be easily moved towards any ways and directions and may be used as a cheering stick/rod (for instance, to perform the moves of a certain choreography), without the risk of said instrument slipping from the user's hand and, thus, providing more safety and comfort to the latter.

On the other hand, since said ludic instrument is completely flexible and can be inflated as a buoy or any other inflatable toy, this cannot hurt anyone when tossed and it cannot even represent a dangerous object usable as a weapon (for instance, as a Billy club) in the event of a possible fight between fans. Hence, this instrument is a harmless object that may be accepted and used in any party or celebration and, more specifically, in football matches.

As already mentioned, the inner central air bag of the ludic instrument invented herein is used as a support handle for the user's hand. However, in an alternative embodiment, it can be configured in order to simultaneously house an air pump suitably connected to a sound reed integrated to the body, in communication with the air enclosed within its double walls. Therefore, since the inner air bag and, as a consequence, the air pump housed therein are intermittently pressed by the user's hand, the air column created through these movements is directed towards said sound reed, thus, producing a sound similar to that of a whistle.

In another alternative embodiment, the inner central air bag of the instrument can be configured to house a honk, which, in this case, is wrapped in the very plastic material used In the instrument. Therefore, when the user's hand intermittently presses said honk a loud sound typical of a honk is produced.

Thus, while in ordinary horns and “vuvuzelas” the sound is produced by the user's blowing through his/her mouth, the sound produced by this flexible and inflatable innovative ludic instrument (be it the sound of a whistle or the sound of a honk) is produced by the user's hand itself, through sequential movements pressing the air pump or the honk placed inside it.

Thus, the use of the ludic instrument invented herein for sound production neither requires major user's effort nor overloads his/her respiratory system, since it only depends on the opening and closing movements of his/her hand, which are movements that can be stopped any time the user wishes without causing the instrument to accidentally slip away from his/her hand; on the contrary, and as it has been already explained, this innovative instrument is anatomically and permanently secured to the user's hand, regardless of the movements that he/she executes, with or without simultaneous sound emission.

Due to all these characteristics, the “FLEXIBLE AND INFLATABLE LUDIC INSTRUMENT” invented herein is a completely innovative object, unique in the market, which can solve the aforementioned drawbacks, since it is harmless, not presenting hard piercing or sharp parts, it is extremely light and flexible and easy to use and handle, both to execute cheering choreographies and visual effects and to produce sound.

Since this novel ludic instrument is adapted to the user's hand and is activated thereby, this instrument may be called “manuzela”¹, as an analogy with the “vuvuzelas” know in the market. ¹ The prefix -man of “manuzeala” derives from the Portuguese word mano (hand).

### DESCRIPTION OF THE DRAWINGS

In order to complement the present description to obtain a better understanding of the characteristics of the present invention, a set of drawings accompanies this specification, the following being shown by these drawings in an exemplary and not limitative manner:

FIGS. 1 to 18 show a first embodiment of the present invention according to which the ludic instrument invented herein is hollow and presents double walls, wherein in the first embodiment option (FIGS. 1 to 8) there is provided the incorporation of a sound reed, whilst in a second embodiment (FIGS. 9 to 18) there is provided the incorporation of a honk. More specifically:

FIG. 1 is a perspective view of said instrument (with sound reed), in an already inflated position.

FIGS. 2, 3 and 4 show the same, respectively in a front, side and top view.

FIG. 5 is a longitudinal section of said instrument, indicated by the line A-A in FIG. 2.

FIG. 6 is an enlarged detail of the instrument, indicated by DET. A in FIG. 5.

FIGS. 7 and 7A show the sound reed integrated in the instrument body, respectively in perspective and top view.

FIG. 8 is a schematic view, showing how the ludic instrument is anatomically and well secured to the user's hand, and how the user's hand may press the air pump housed in the inner central air bag of the instrument, in order to create an air column directed towards the sound reed incorporated therein.

FIG. 9 is a perspective view of said instrument (with honk) in an already inflated position.

FIGS. 10, 11 and 12 show the same, respectively in front, side and top view.

FIG. 13 is a longitudinal section of said instrument, indicated by line B-B in FIG. 10.

FIG. 14 is an enlarged detail of the instrument, indicated by DET. B in FIG. 13.

FIGS. 15 and 15A show the honk that is incorporated to the instrument body, respectively in perspective and top view.

FIG. 16 is another longitudinal section of said instrument, indicated by line C-C in FIG. 11.

FIG. 17 is an enlarged detail of the instrument, indicated by DET. C in FIG. 18.

FIG. 18 is a schematic view which likewise shows how the ludic instrument is anatomically and well secured to the user's hand, and how the user's hand can press the honk wrapped in the inner central part of the instrument in order to allow actuating said honk.

FIGS. 19 to 25 show a second alternative embodiment of the present invention, according to which the ludic instrument invented herein is closed and consists of a single wall, wherein the first alternative embodiment (FIGS. 9 to 18) also describes the incorporation of a sound reed, whilst the second alternative embodiment (FIGS. 19 to 25) there is described the incorporation of a honk. More specifically:

FIG. 19 is a perspective view of said instrument (with honk) in an already inflated position.

FIGS. 20, 21 and 22 show the same, respectively in front, side and top view.

FIG. 23 is a longitudinal section of said instrument, indicated by line D-D in FIG. 20.

FIGS. 24 and 24A show the honk which is incorporated in the instrument body, respectively in perspective and front view.

FIG. 25 is a schematic view, which likewise shows how the ludic instrument is anatomically and well secured to the user's hand and how the user's hand may press the honk wrapped in the inner central part of the instrument in order to allow actuating said honk.

Finally, FIGS. 28 and 27 show respectively a perspective and a side view of a third alternative embodiment of the present invention, according to which the ludic instrument invented herein is likewise hollow and it consists of double walls, such as in the first embodiment, although its handle is substantially longer and may be additionally secured to the user's forearm through a suitable clamping element.

### DETAILED DESCRIPTION OF THE INVENTION

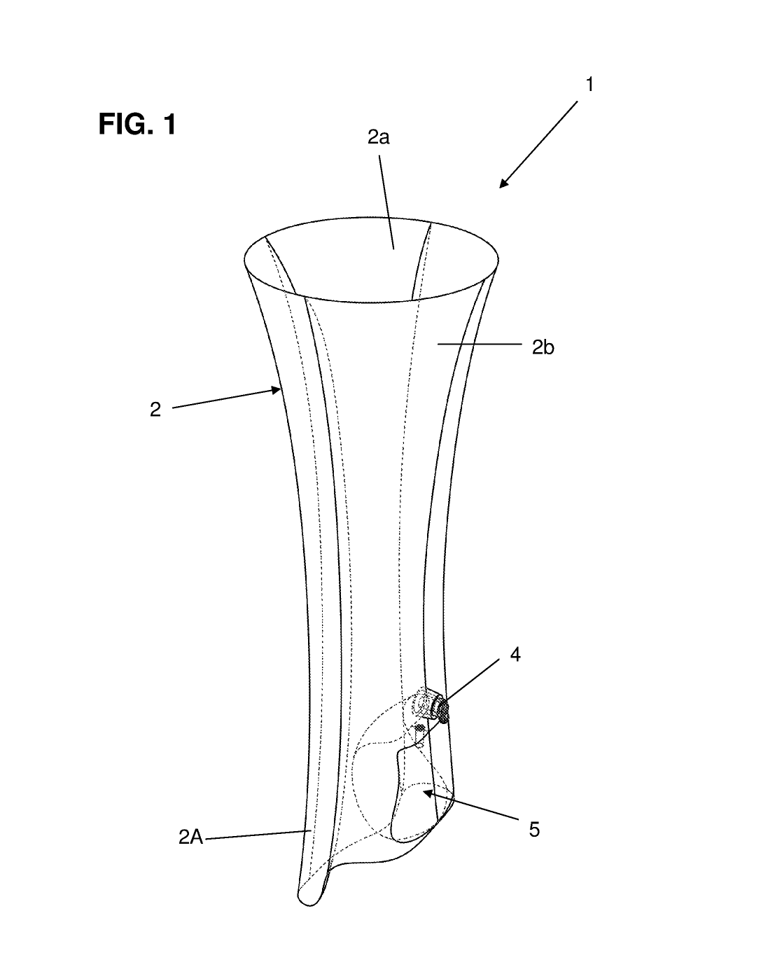

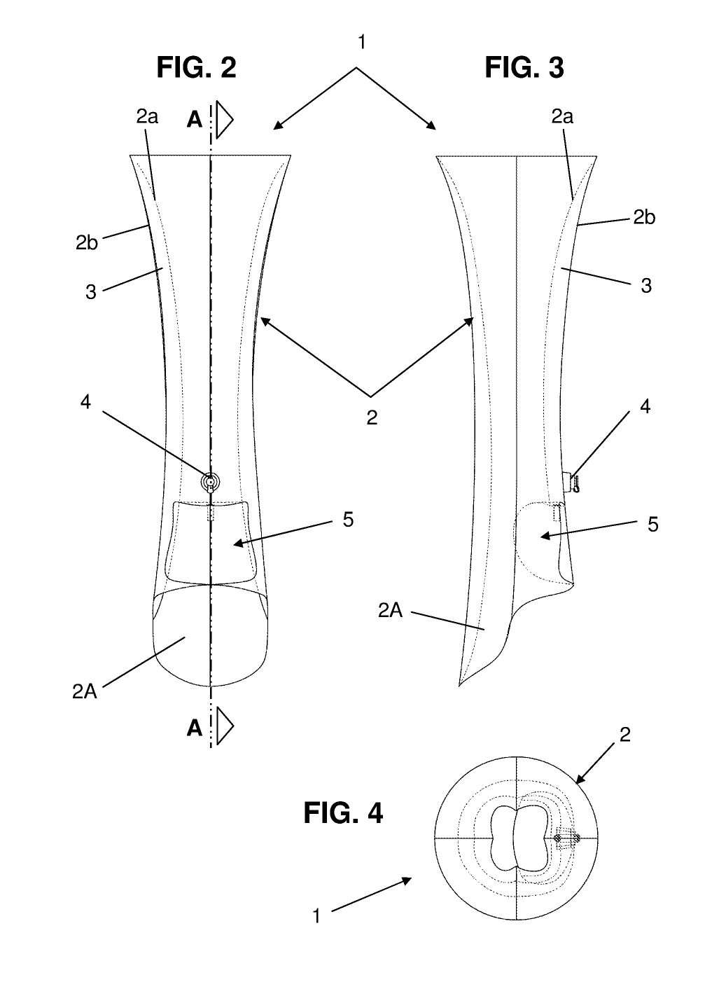

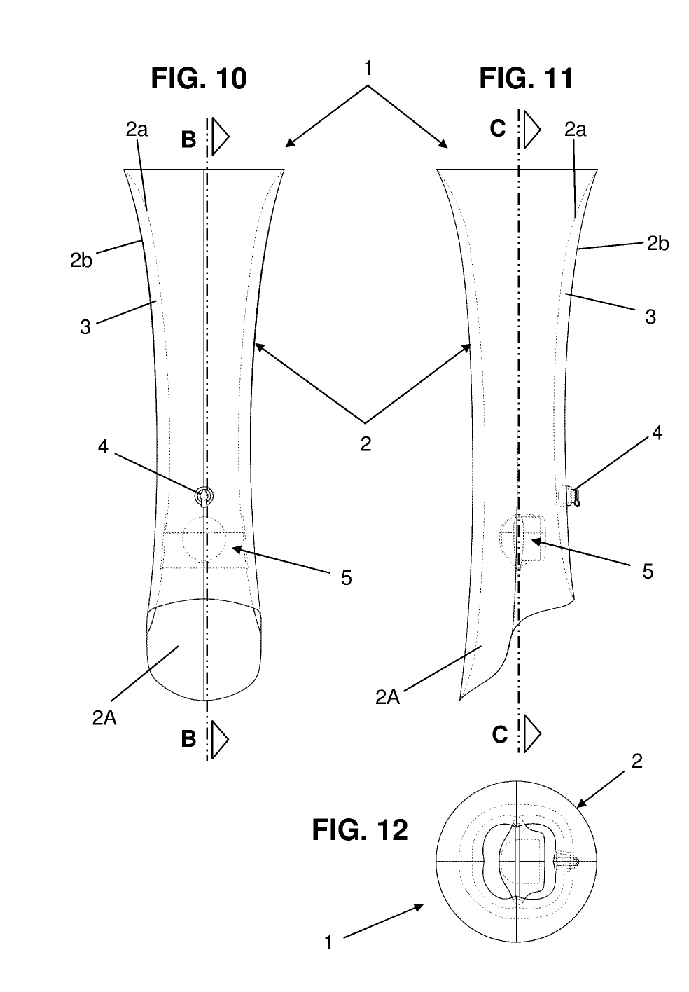

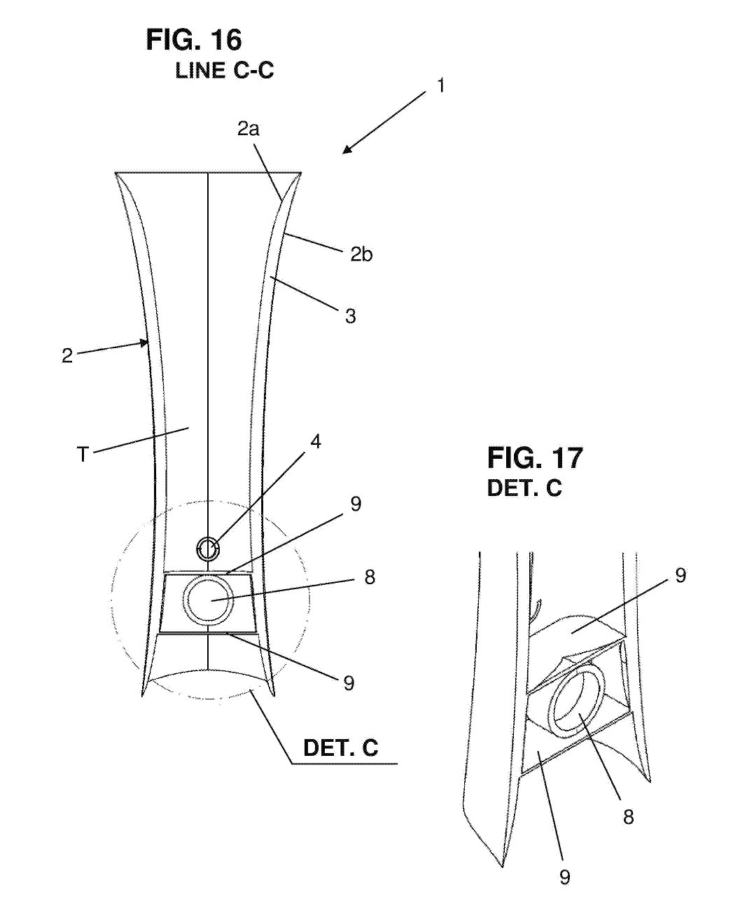

The subject matter of the present Patent of Invention is a “FLEXIBLE AND INFLATABLE LUDIC INSTRUMENT” (1) which, in a first embodiment, shown in FIGS. 1 to 18, consists of a hollow body (2) made of suitable flexible plastic material, preferably polypropylene (PP), and consisting of double walls—an inner (2a) and an outer (2b) wall, which delimit an air chamber (3) between them; the body (2) can be quickly inflated, both manually and mechanically (with compressed air), through an air inlet valve (4) provided in any suitable place of its outer wall (2b).

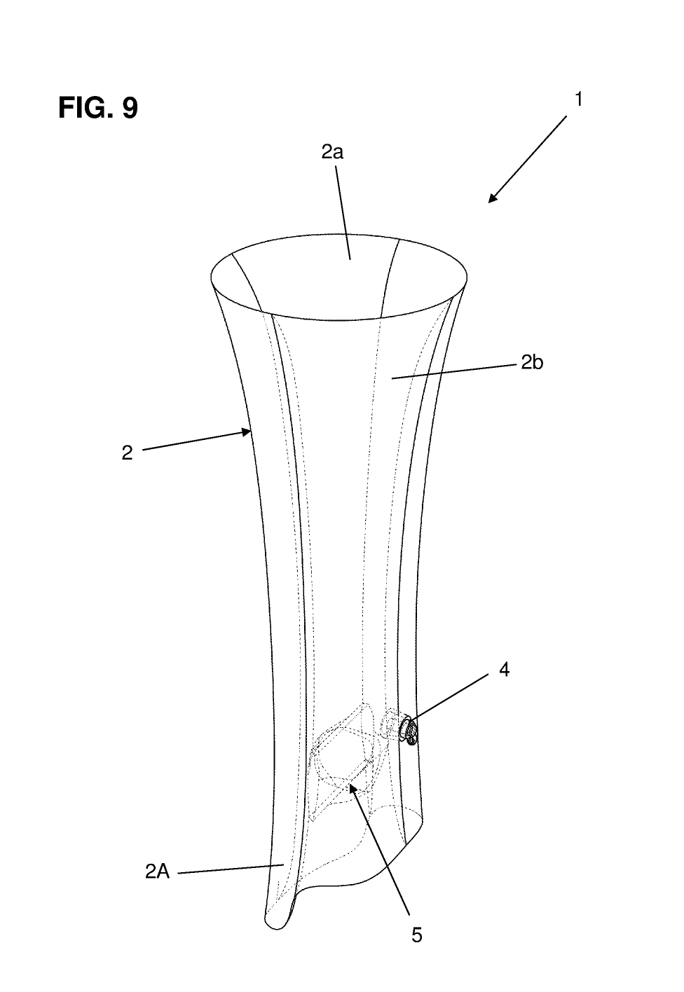

Upon inflation, said body (2) takes the shape of a horn, as shown in FIGS. 1 and 9, the bottom part of said body (2) presenting a handle (2A) capable of allowing its adaptation to the user's hand, more specifically to is wrist, being well secured thereto.

In other words, upon inflation of the instrument (1) through the air inlet valve (4) provided therein, the user's hand may be introduced in the inner tube (T) formed thereby, In the manner of a glove, such procedure being guided and facilitated by said bottom handle (2A), said instrument (1) being secured and anatomically adapted to the user's hand.

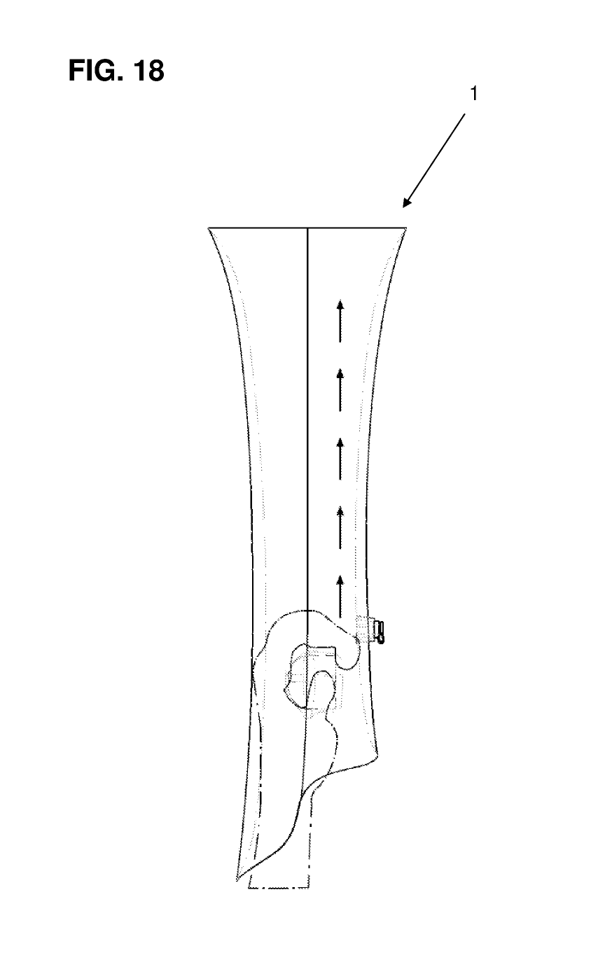

Moreover, the body (2) presents an inner central air bag (5), delimited by the flexible plastic material it is made of, this bag (5) feeing positioned so as to coincide with the user's hand when he/she introduces his/her hand in the instrument, his/her fingers comfortably laying thereon; thus, said air bag (5) works as a support handle in the middle of the inner tube (T) delimited by the instrument, whereby the latter is even better secured to the user's hand (see more specifically FIGS. 8 and 18).

Therefore, since the ludic instrument (1) invented herein is “worn” by a user's hand it may be easily moved towards any ways and directions and may be used as a cheering stick/rod (for instance, to perform the moves of a certain choreography), without the risk of said instrument slipping from the user's hand and, thus, providing more safety and comfort to the user.

On the other hand, since said ludic instrument (1) is completely flexible and can be inflated as a buoy or any other inflatable toy, it cannot hurt anyone when tossed and it cannot even represent a dangerous object usable as a weapon (for instance, as a Billy club) in the event of a possible fight between fans. Hence, this instrument (1) is a harmless object that may be accepted and used in any party or celebration and, more specifically, in football matches.

As it has been already mentioned, the inner air bag (5) of the ludic instrument (1) is used as a support handle for the user's hand. However, in addition to this function, said inner air bag (5) may be configured to house simultaneously a. sound reed and a honk, as explained below.

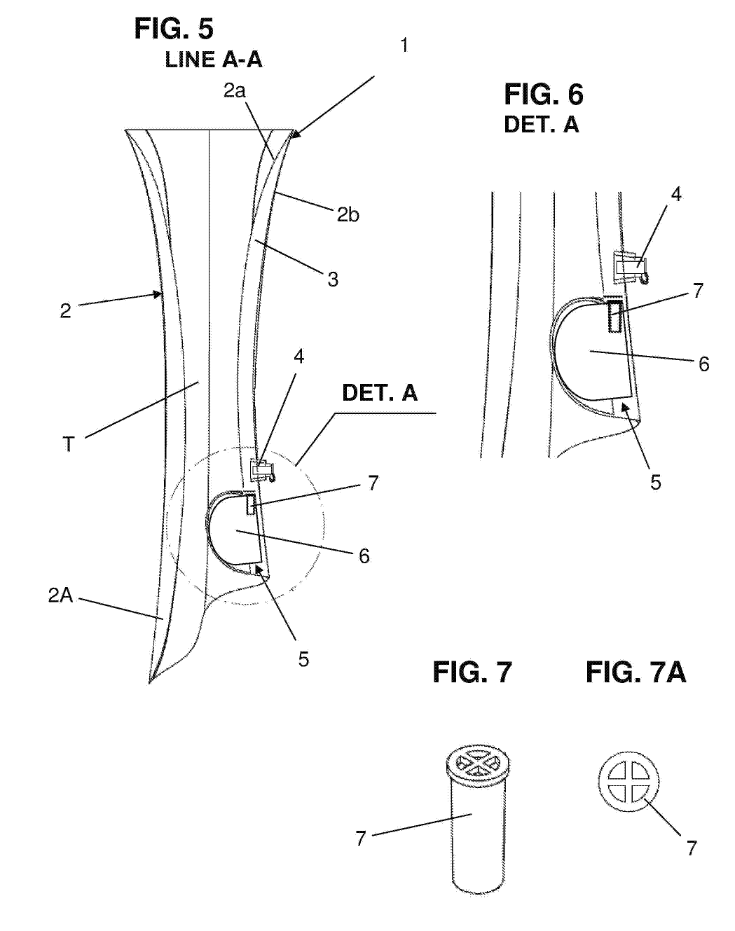

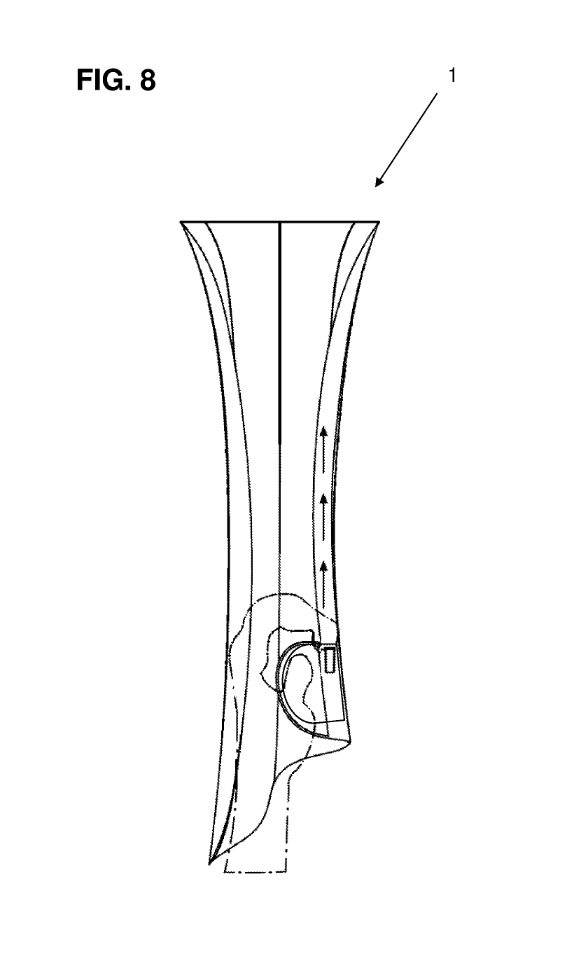

In a first embodiment option, shown in FIGS. 1 to 8, said air bag (5) simultaneously configures a housing for an air pump (8) suitably connected to a sound reed (7) integrated to the body (2), in communication with the air chamber (3) enclosed within the double walls (2a/2b) that make up the same, as it is shown better in the sectional and the enlarged detail views of FIGS. 5 and 6; an example of sound reed (7) which may be used in the instrument (1) is shown in attached FIGS. 7 and 7A.

Therefore, when the inner air bag (5) and, thus, the air pump (6) housed inside the same are intermittently pressed by the user's hand, the air column produced by means of these movements is directed towards said sound reed (7), and from this towards an air chamber (3), resulting in the emission of a sound similar to that of a whistle (please see FIG. 8).

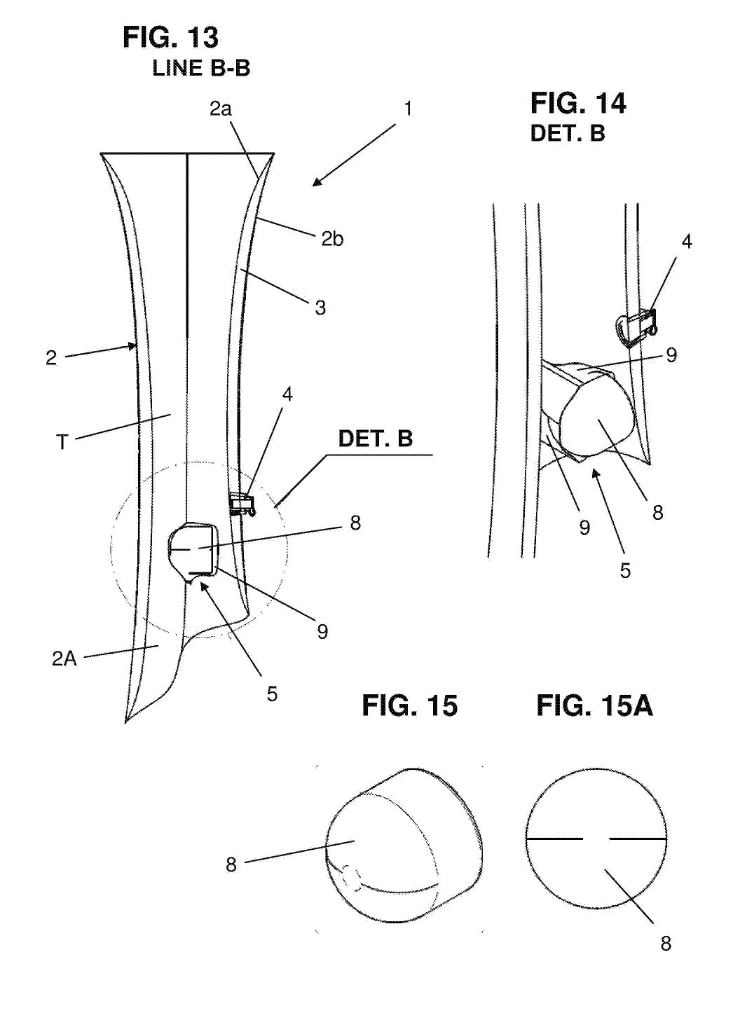

In a second embodiment option, shown in FIGS. 9 to 18, the inner central air bag (5) of the ludic instrument (1) may configure a housing for a honk (8), which, in this case, is enclosed between walls (9) configured by the very plastic material used in the body (2) of the instrument, as shown better in the sectional and in the detail views of FIGS. 13 and 14, and 16 and 17; an example of a honk (8) which may be used in instrument (1) is illustrated in attached FIGS. 15 and 15A.

Hence, when the inner air bag (5) and, thus, the honk (8) are intermittently pressed by the user's hand, the sound produced thereby is emitted (please see FIG. 18).

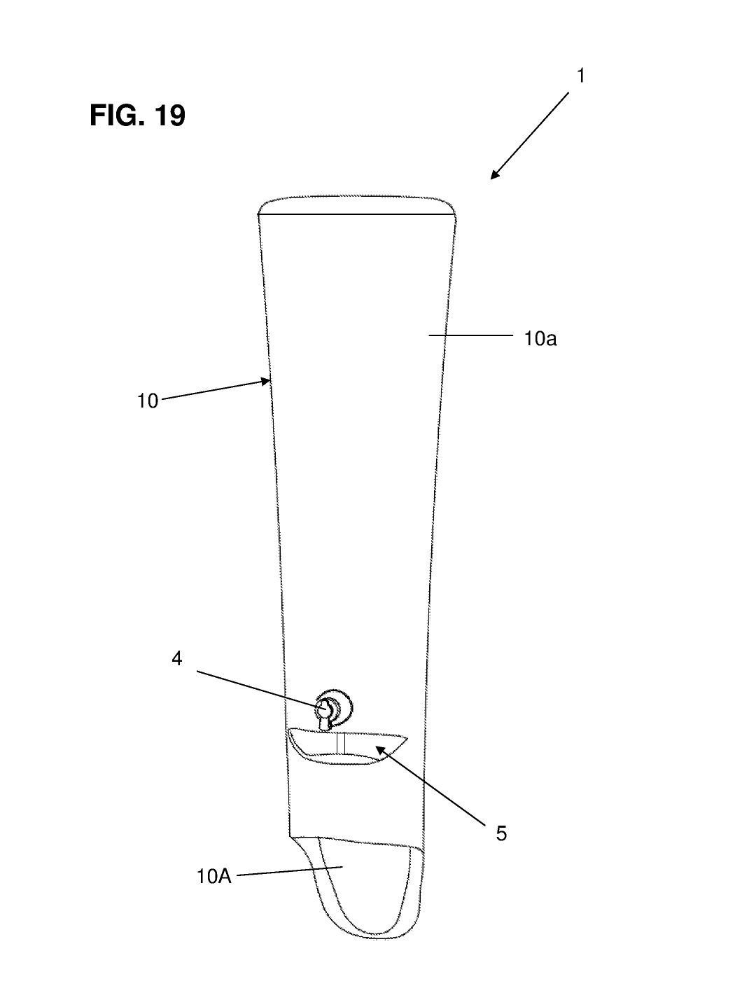

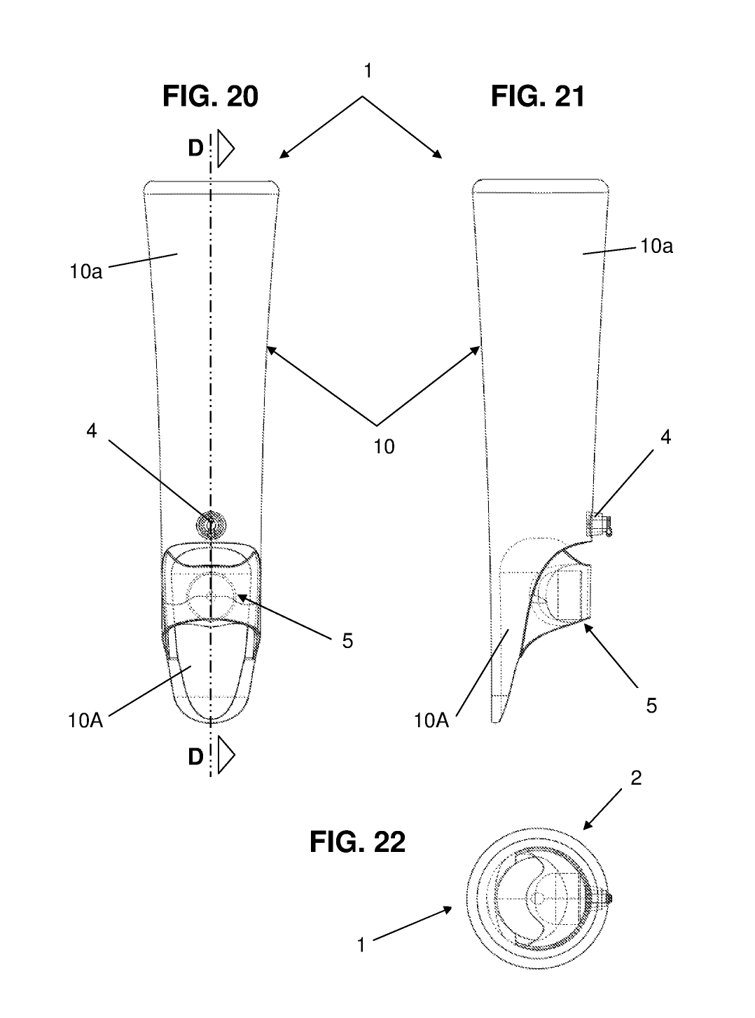

In a second alternative embodiment of the instant invention, shown in FIGS. 19 to 25, the ludic instrument (1) consists of a non-hollow body (10), that is, closed at both ends, likewise made of suitable flexible plastic material, preferably polypropylene (PP), and formed by a single wall (10a); said body (10) likewise manually or mechanically inflatable through the same air inlet valve (4) provided therein, the inflation of said body (10) resulting in the formation of an object with a shape of a truncated cone; thus, upon inflation of said body (10) through the valve (4) the former is completely filled with air, delimiting an inner tube (3) which covers the entire body.

In this embodiment the lower part of said body (10) also presents a handle (10A) capable of allowing its adaptation to the user's hand, such handle presenting the same inner central air bag (5), delimited by the flexible plastic material whereof the body is made.

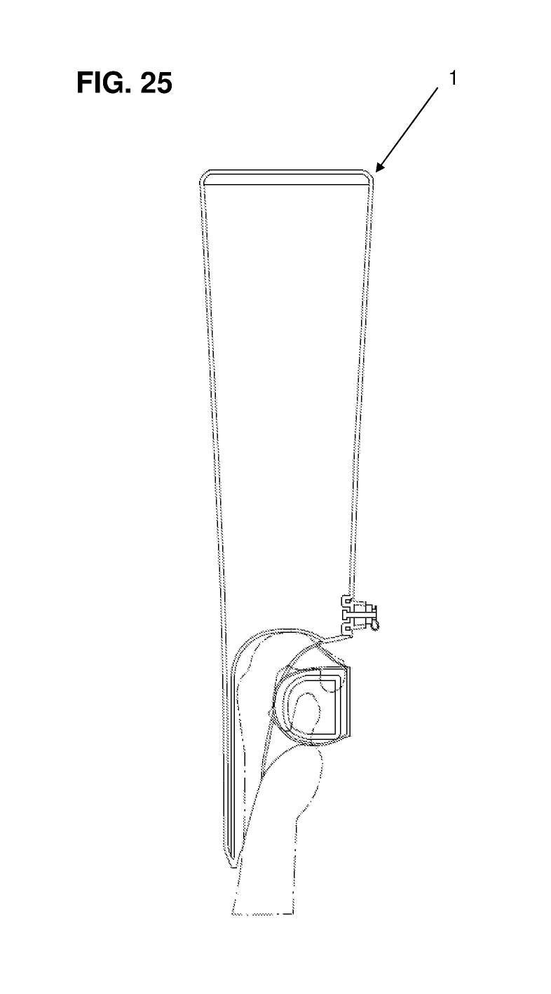

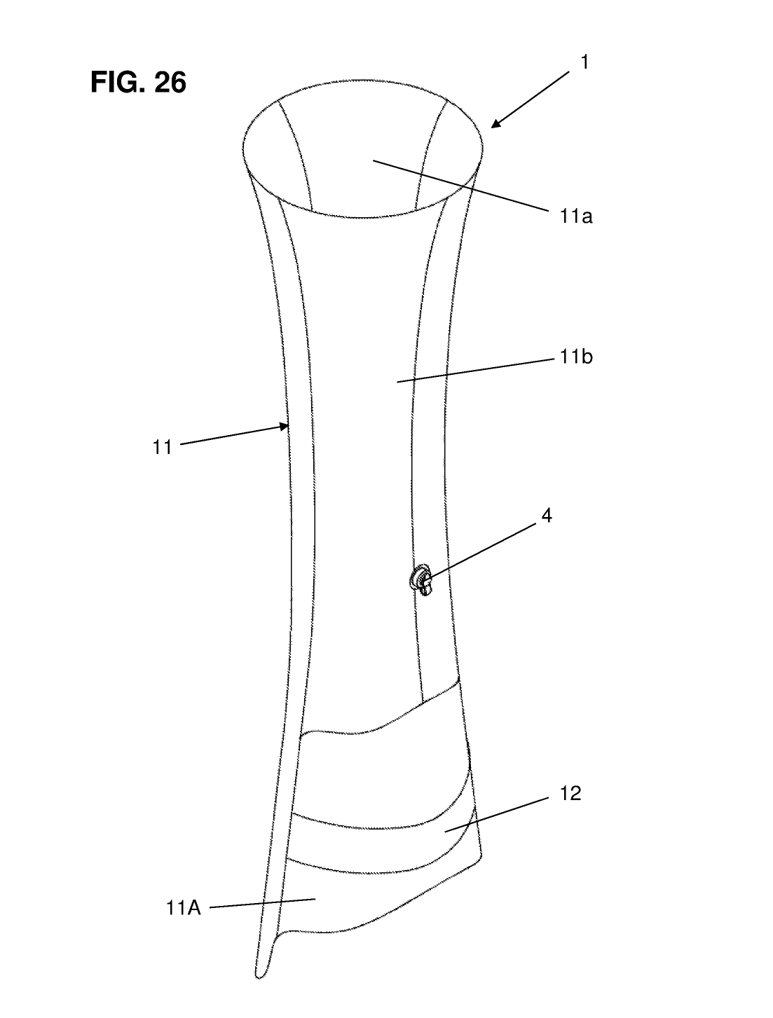

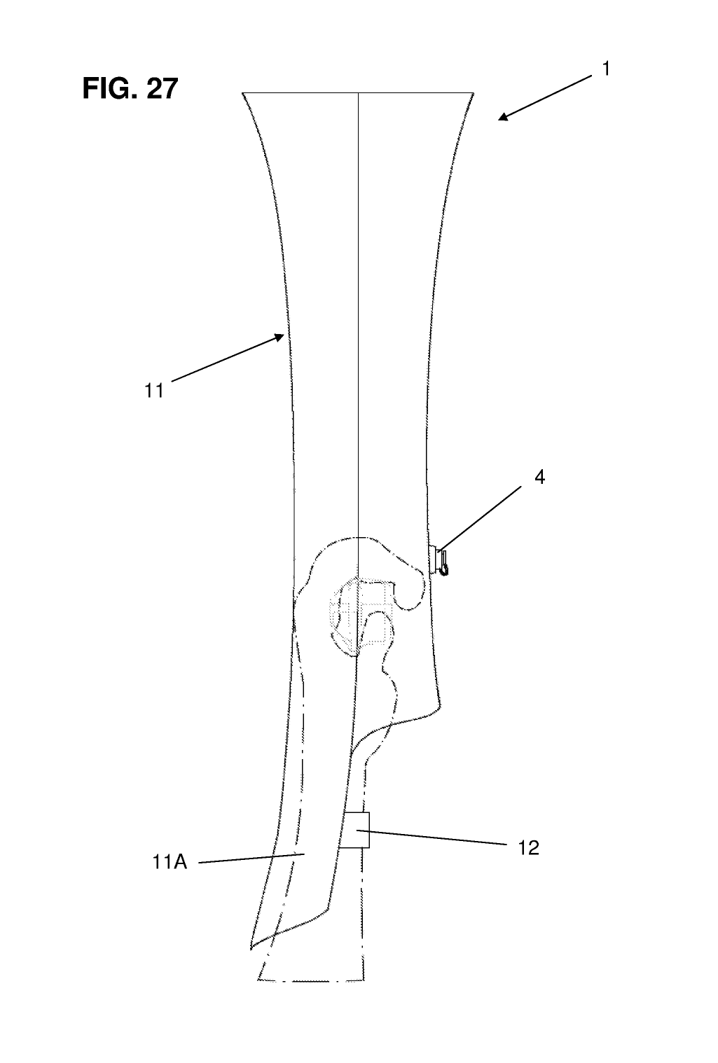

As provided in both the embodiment options of the first embodiment, when the user introduces his/her hand into the ludic instrument (1), his/her fingers comfortably lay on said air bag (5) which thus works as a support handle through which said instrument is well secured to the user's hand (see FIG. 25).

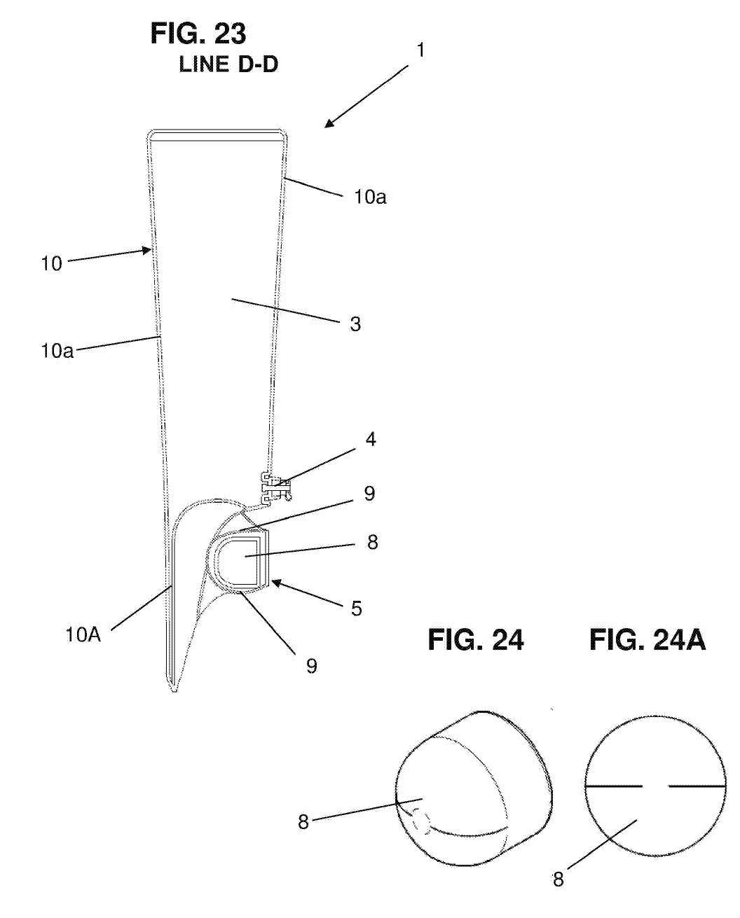

Furthermore, as provided in those two embodiment options, the air bag (5) of the ludic instrument (1) may configure a housing for an air pump (6) connected to a sound reed (7), or a housing for a honk (8). In the attached FIGS. 19 to 25 there is shown the embodiment option involving a honk (8) inside said air bag (5), said honk (8) being likewise enclosed within walls (9) configured by the very plastic material of the instrument body (2), as shown better in the section view of FIG. 23.

In this alternative embodiment, the same type of honk (8) used in the second option of realization of the first alternative embodiment of the invention (FIGS. 15 and 15A) may be used, as shown in FIGS. 24 and 24A.

As shown in FIG. 25, when the inner air bag (5) and, thus, the honk (8) are intermittently pressed by the user's hand, the produced sound is emitted.

Lastly, in a third alternative embodiment of the present invention, shown in FIGS. 26 and 27, the ludic instrument (1) invented herein consists of a body (11) which is likewise hollow and formed by double walls (11a) and (11b), such as in the first alternative embodiment (FIGS. 1 to 18), however its handle (11A) is substantially longer in order to coincide with the user's forearm and presents a clamping element (12), such as an elastic band, a belt or an adjustable strap through which said instrument (1) is secured to said user's forearm, providing an additional fastening point (see FIG. 27).

The ludic instrument (1) invented herein may be manufactured in any color or pattern, or may receive the application of any colored film to form any drawing, including with the combination of two or more colors.

When the instruments (1) are used in games or matches of any sport, their colors may be consistent with the colors of the clubs, teams or countries which are competing in order to configure entertainment elements to be used both individually and collectively by the fans to execute choreographies and games presented in stadiums, as those currently taking place.

Furthermore, any logotype and/or trademark of potential manufacturers or sponsors may be applied to such ludic instruments (1), which would work as an excellent means of communication, advertising and marketing.

1. A flexible and inflatable ludic instrument comprising a body made of suitable flexible plastic material, formed by one or more walls delimiting an air chamber which is inflatable through an inlet valve provided in a suitable place of its external wall, wherein said body takes a shape of a horn, whose bottom part presents an anatomic handle adaptable to a user's hand, which is introduced in an inner tube formed by said body, directed by said handle; said body-presenting an inner central air bag, delimited by the very flexible plastic material it is made of, said air bag presenting a central support handle to support the user's hand, as well as for housing an air pump connected to a sound reed or for a honk; the activation of said air pump or of said honk by the user's hand results in an emission of sound by the instrument.

2. The flexible and inflatable ludic instrument according to claim 1, wherein the body forming said instrument is a non-hollow body, closed at both ends, formed by a single wall which delimits the air chamber, and can be likewise inflated through the air inlet valve provided therein, the inflation of said body resulting in the formation of an object with a shape of a truncated cone whose bottom part presents the anatomic handle adaptable to the user's hand.

3. The flexible and inflatable ludic instrument according to claim 1, wherein the body of said instrument is a hollow body whose bottom part or handle is longer, coinciding with the user's forearm, and wherein is provided a damping element securing the instrument to the user's forearm to provide further fastening.

4. The flexible and inflatable ludic instrument according to claim 1, wherein said sound reed integrated to the body communicates with the air chamber, the air column created by the pressure of the user's hand on the air pump housed in said inner air bag being directed towards said sound reed, and from this towards the air chamber, emitting a sound similar to that of a whistle.

5. The flexible and inflatable ludic instrument according to claim 1, wherein said honk integrated in the body is enclosed within walls configured by the very plastic material used in said body, the pressure of the user's hand on the honk enclosed within the walls producing the emission of a sound typical of a honk.

6. The flexible and inflatable ludic instrument according to claim 3, wherein said clamping element is an elastic band.

7. The flexible and inflatable ludic instrument according to claim 3, wherein said clamping element is a belt.

8. The flexible and inflatable ludic instrument according to claim 3, wherein said clamping element is an adjustable strap.

9. The flexible and inflatable ludic instrument according to claim 1, wherein said instrument is manufactured in any color or pattern.

10. The flexible and inflatable ludic instrument according to claim 1, wherein said instrument receives the application of any colored film forming any drawing, combining two or more colors.

11. The flexible and inflatable ludic instrument according to claim 1, wherein the colors of said instrument are consistent with the colors of the clubs, teams or countries, configuring elements similar to Billy clubs/sticks used by fans and uniform fan groups to perform choreographies.

12. The flexible and inflatable ludic instrument according to claim 1, wherein said instrument receives an application of logotypes and/or trademarks of potential manufacturers or sponsors, working as a means of communication, advertising and marketing.

13. The flexible and inflatable ludic instrument according to claim 1, wherein the body is formed by double walls of an inner wall and an outer wall, and wherein the inner wall and outer wall delimit the air chamber between them.

14. The flexible and inflatable ludic instrument according to claim 2, wherein said sound reed integrated to the body communicates with the air chamber, the air column created by the pressure of the user's hand on the air pump housed in said inner air bag being directed towards said sound reed, and from this towards the air chamber, emitting a sound similar to that of a whistle.

15. The flexible and inflatable ludic instrument according to claim 13, wherein said sound reed integrated to the body communicates with the air chamber, the air column created by the pressure of the user's hand on the air pump housed in said inner air bag being directed towards said sound reed, and from this towards the air chamber, emitting a sound similar to that of a whistle.

16. The flexible and inflatable ludic instrument according to claim 2, wherein said honk integrated In the body is enclosed within walls configured by the very plastic material used in said body, the pressure of the user's hand on the honk enclosed within the walls producing the emission of a sound typical of a honk.

17. The flexible and inflatable ludic instrument according to claim 13, wherein said honk integrated in the body is enclosed within walls configured by the very plastic material used in said body, the pressure of the user's hand on the honk enclosed within the walls producing the emission of a sound typical of a honk.
